(19) United States
(12) Patent Application Publication
(10) Pub. No.: US 2011/0259977 A1
(43) Pub. Date: Oct. 27, 2011

(54) Water passage for embedded rotary sprinkler

(75) Inventor: Shun-Nan Lo, Taichung (TW)

(73) Assignee: YUAN-MEI CORP.

(21) Appl. No.: 12/662,578

(22) Filed: Apr. 23, 2010

(51) Int. Cl. B05B 3/04

(52) U.S. Cl. 239/240

(57) ABSTRACT

A water passage for embedded rotary sprinkler includes upper and lower tubes and upper and lower covers so as to form first and second independent chambers, integral water path, and upper and lower independent chambers. The first and lower independent chambers has clockwise and counterclockwise water paths. An outer ring water path connecting the first independent chamber is formed to the lower tube. A transmission gear is arranged inside the second independent chamber. A driving shaft having an upward open is arranged between the second and the lower independent chambers. An upper end of the driving shaft is connected by a nozzle, and a plurality of lateral hole is formed to a middle of the driving shaft in the upper independent chamber. A lower end of the driving shaft having a gear engaging the transmission gear is inside the second independent chamber.

### FIELD OF THE INVENTION

The present invention relates to sprinkler, and particular to a water passage for embedded rotary sprinkler capable of releasing pressure automatically so as to prevent a breakage of component.

### DESCRIPTION OF THE PRIOR ART

Published patents such as U.S. Pat. Nos. 7,478,526, 7,434,747, 6,929,194, and 6,840,460 disclose different water flow passages and methods for alternate rotation of sprinkler. However, without a pressure release function, leak will easily happened between components under a high water pressure.

Therefore, through many trials and experiments, the inventor of the present invention provide a water passage for embedded rotary sprinkler capable of releasing pressure automatically.

### SUMMARY OF THE PRESENT INVENTION

The primary object of the present invention is to provide an embedded rotary sprinkler capable of releasing pressure automatically. To achieve the object, the present invention having water paths assembled by upper and lower tubes and covers will release excess pressurized water to prevent a breakage.

### BRIEF DESCRIPTION OF THE DRAWINGS

FIG. 1 is an exploded view showing a preferable embodiment of the present invention.

FIG. 2 is another exploded view showing the preferable embodiment of the present invention.

FIG. 3 is a top view of the preferable embodiment of the present invention.

FIG. 4 is a cross-section view through an A-A line of the FIG. 3.

FIG. 5 is a cross-section view through a B-B line of the FIG. 3.

FIG. 6 is a cross-section view through a C-C line of the FIG. 3.

FIG. 7 is a cross-section view through a D-D line of the FIG. 3.

FIG. 8 is a cross-section view through a E-E line of the FIG. 3.

FIG. 9 is a cross-section view showing the preferable embodiment of the present invention.

FIG. 10 is another cross-section view showing the preferable embodiment of the present invention.

FIG. 11 is a top view showing an upper tube of the present invention.

FIG. 12 is an upward stereograph showing the upper tube of the present invention.

FIG. 13 is a cross-section view through a F-F line of the FIG. 11.

FIG. 14 is a cross-section view through a G-G line of the FIG. 11.

FIG. 15 is a vertical stereograph showing a lower tube of the present invention.

FIG. 16 is an upward stereograph of the lower tube of the present invention.

FIG. 17 is a top view of the lower tube of the present invention.

FIG. 18 is an upward view of the lower tube of the present invention.

FIG. 19 is a cross-section view through a H-H line of the FIG. 17.

FIG. 20 is a cross-section view through an I-I line of the FIG. 17.

FIG. 21 is a cross-section view through a J-J line of the FIG. 17.

FIG. 22 is a cross-section view through a K-K line of the FIG. 17.

FIG. 23 is a schematic view showing a preferable embodiment of a transmission gear of the present invention.

FIG. 24 is a schematic view showing an embedded rotary sprinkler of the present invention.

FIG. 25 is a schematic view showing an operation of the embedded rotary sprinkler of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

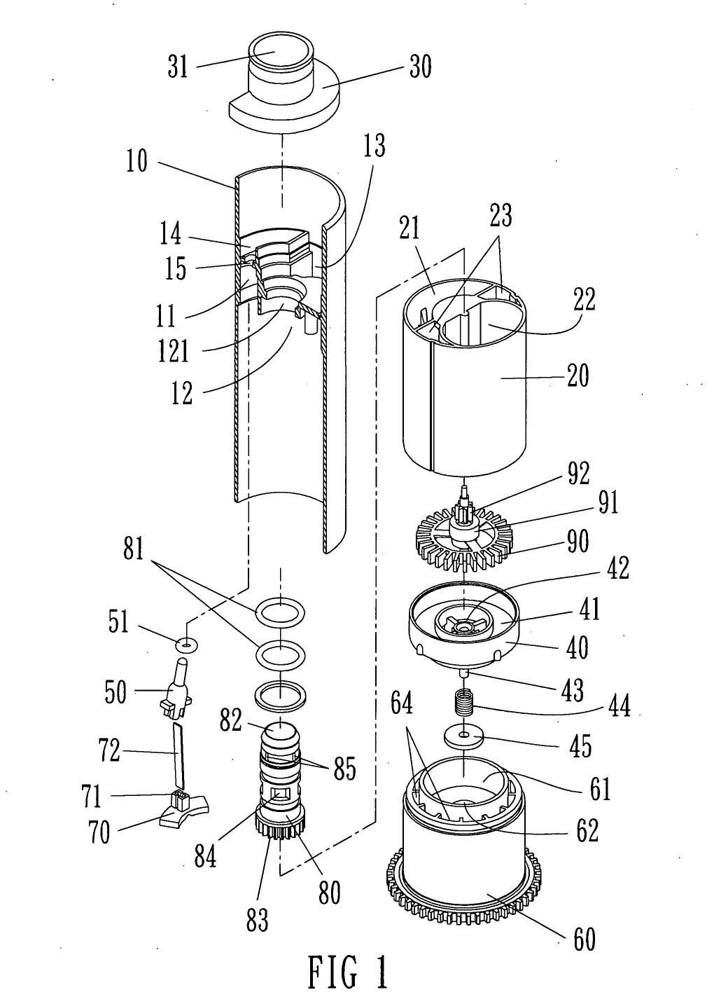

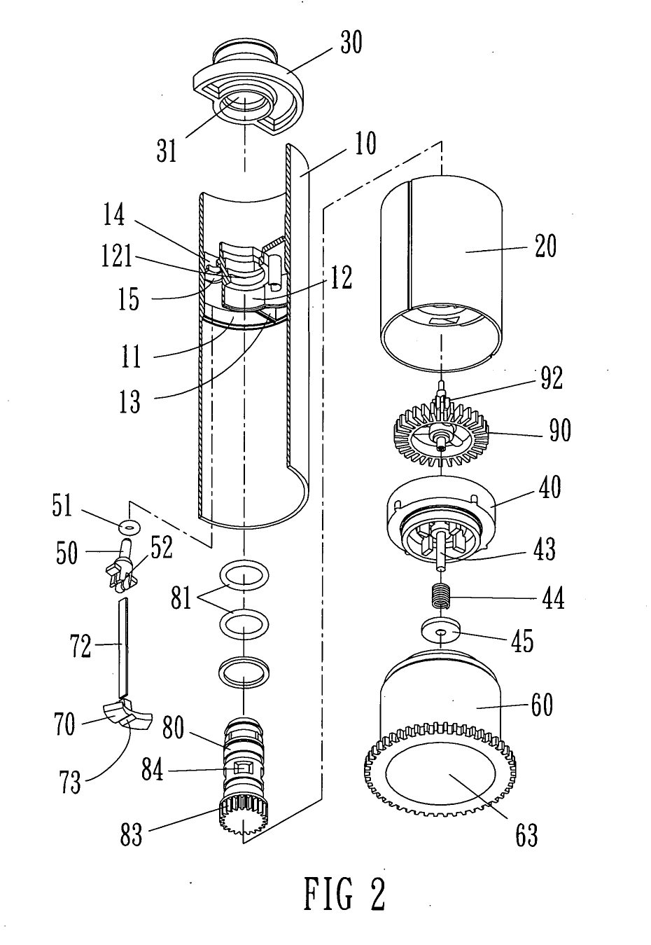

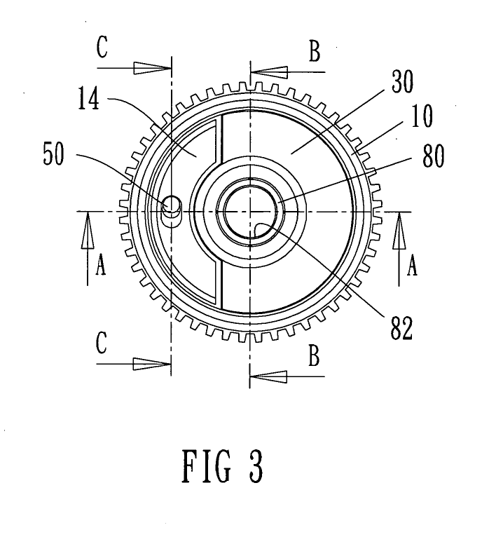

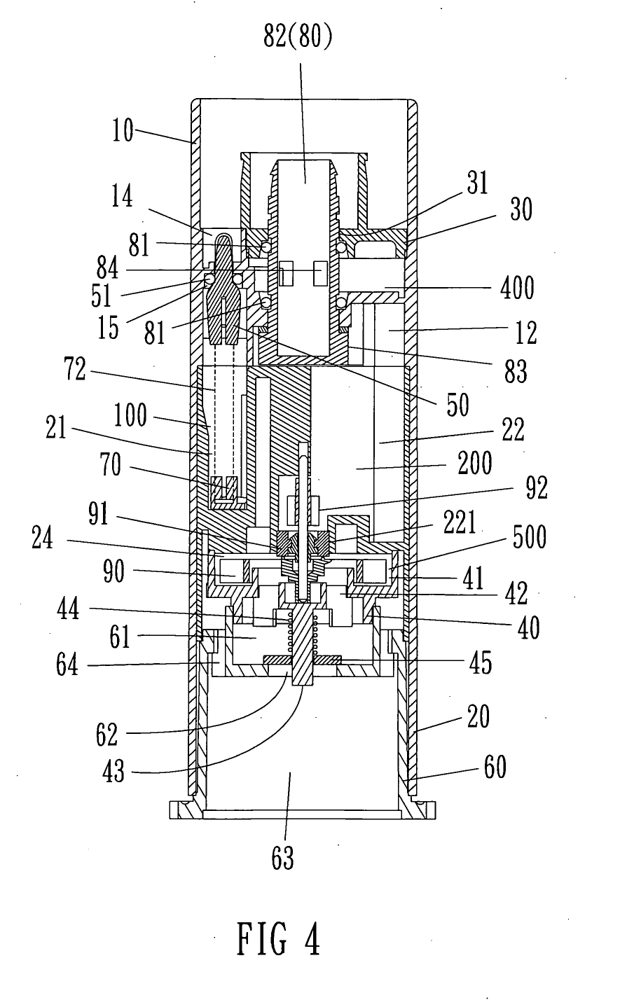

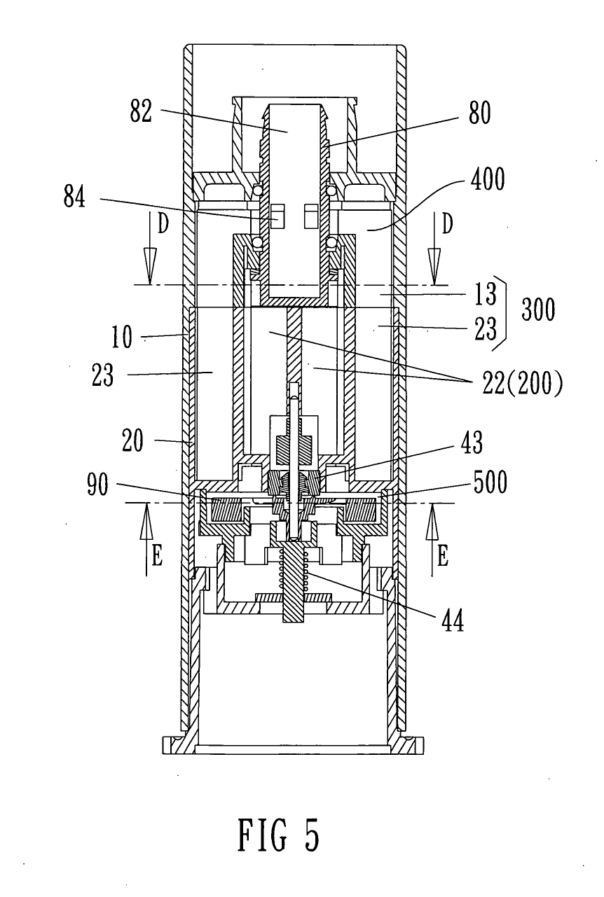

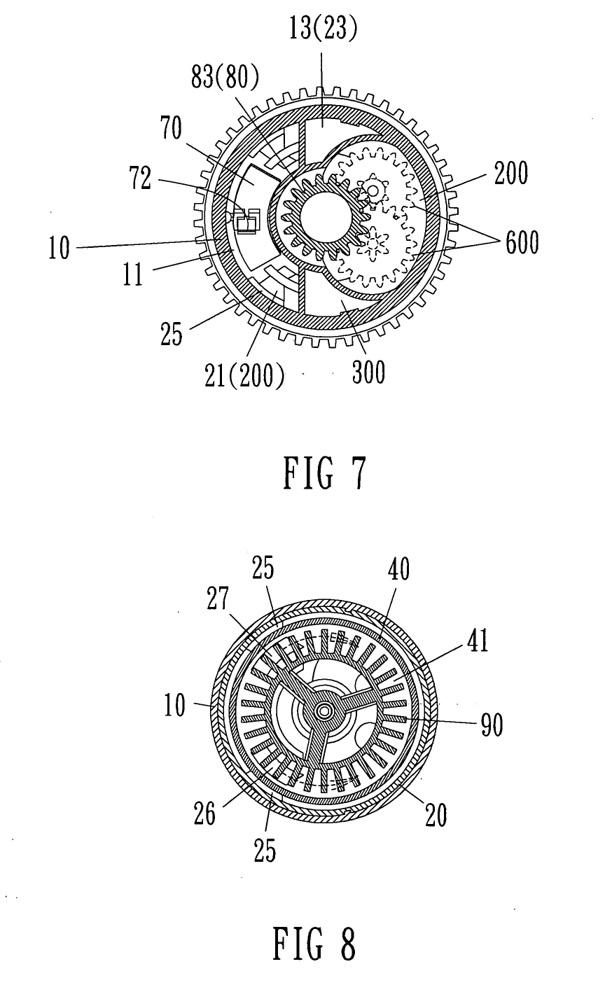

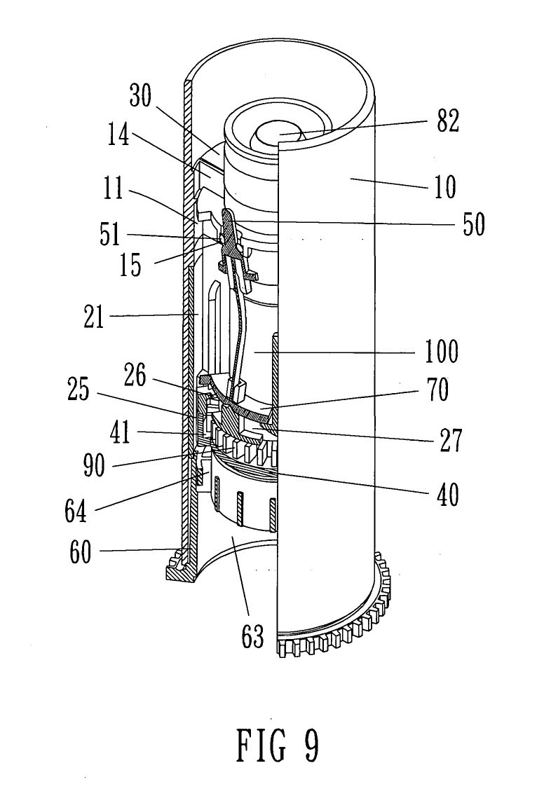

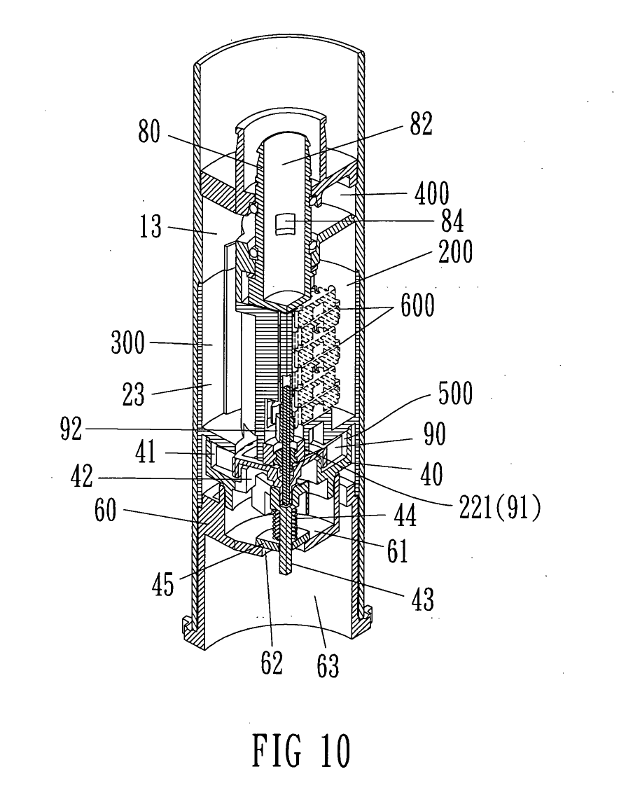

Referring to FIGS. 1 to 10, a water passage for embedded rotary sprinkler according to the present invention is illustrated. The water passage for embedded rotary sprinkler includes an upper tube 10, lower tube 20, upper cover 30, and a lower cover 40. A first independent chamber 100, second independent chamber 200, integral water path 300, upper independent chamber 400, and a lower independent chamber 500 are formed inside of embedded rotary sprinkler. The first independent chamber 100 communicates with the lower independent chamber 500. The lower independent chamber 500 communicates with the integral water path 300. The integral water path 300 communicates with the upper independent chamber 400. A circuitous path of water is formed.

The above components are further described in the following.

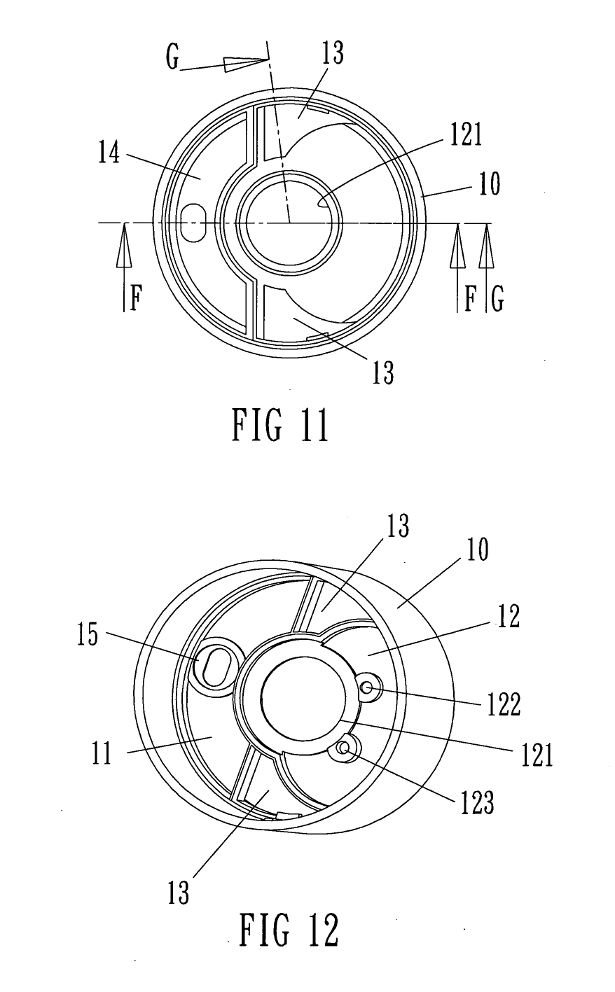

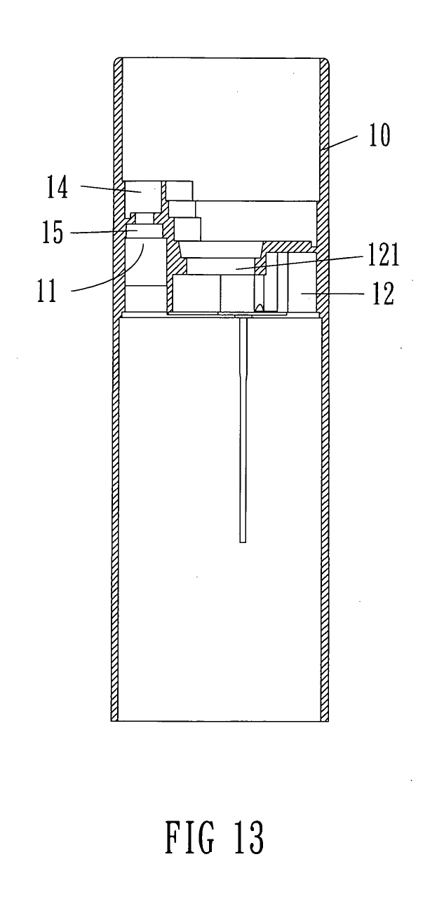

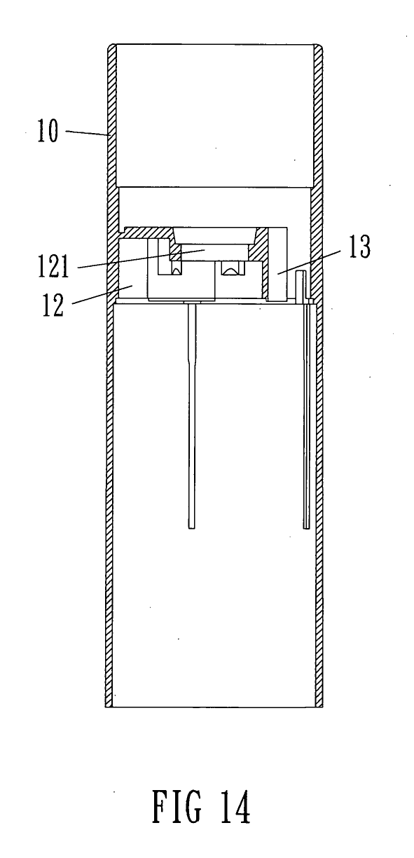

Referring to FIGS. 11 to 14, the upper tube 10 has a first upper receiving chamber 11 and a second upper receiving chamber 12 inside thereof. An upper water path 13 is formed between the first and the second upper receiving chamber 11 and 12. A top receiving chamber 14 is formed separately to a top of the upper receiving chamber 11. The upper cover 30 is arranged to the top receiving chamber 14 so that the upper independent chamber 400 is formed between the upper cover 30 and a relative top of the second upper receiving chamber 12. A through hole 15 is formed between the first upper receiving chamber 11 and the top receiving chamber 14. A water seal ring 51 and a rod 50 are arranged to the through hole 15. The water seal ring 51 is arranged between the through hole 15 and the rod 50 so that the rod 50 is positioned and capable of swinging left and right. An upper axial through hole 121 is formed to a top of the second upper receiving chamber 12. A first upper axial hole 122 and second upper axial hole 123 are formed next to the upper axial through hole 121 with a predetermined gap. A recess 52 is formed to a bottom of the rod 50 so as to receive a top of a long twisting sheet 72.

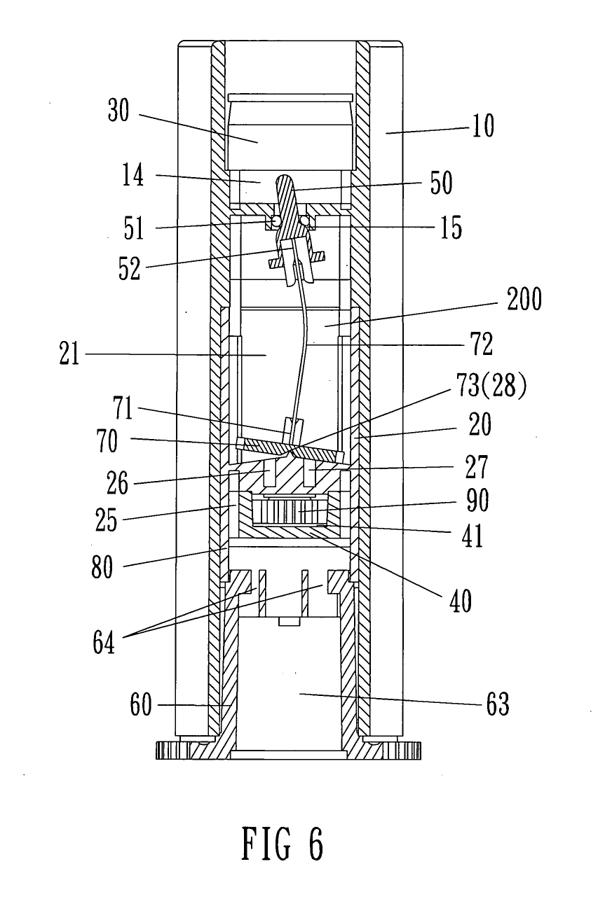

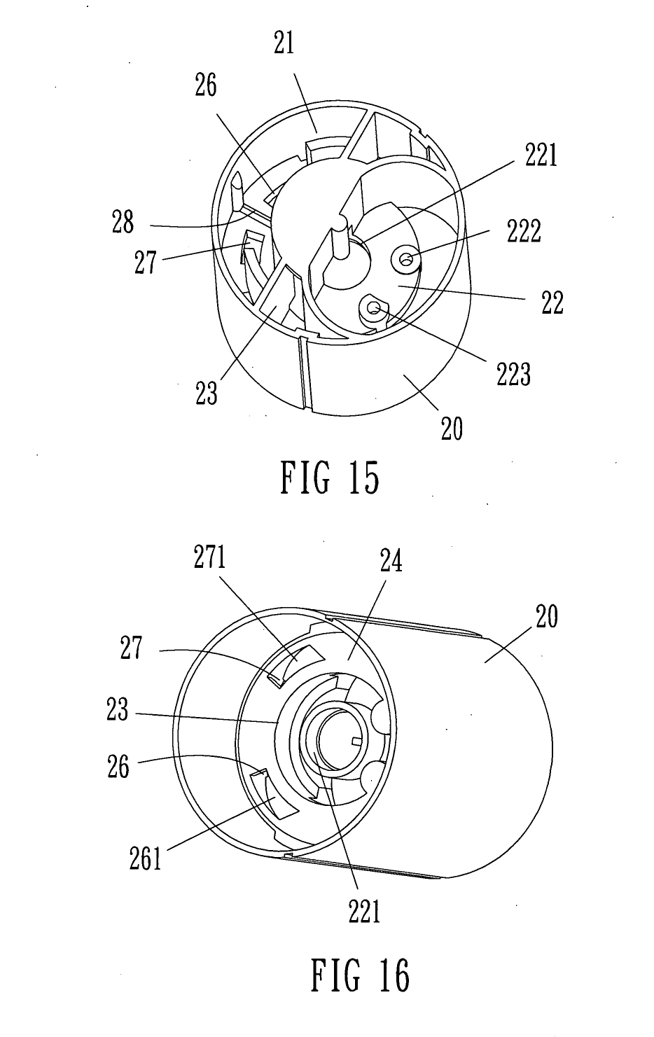

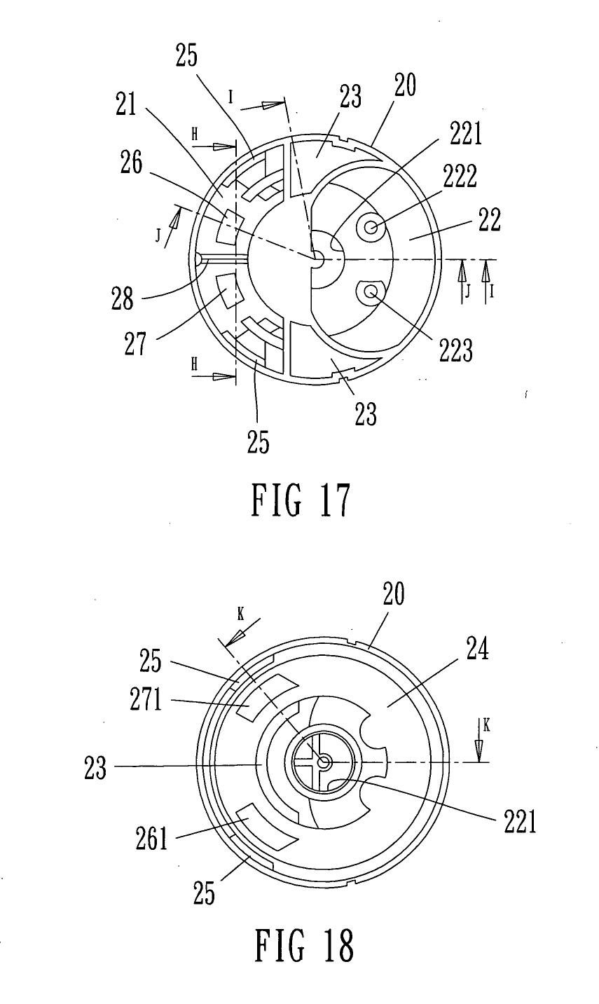

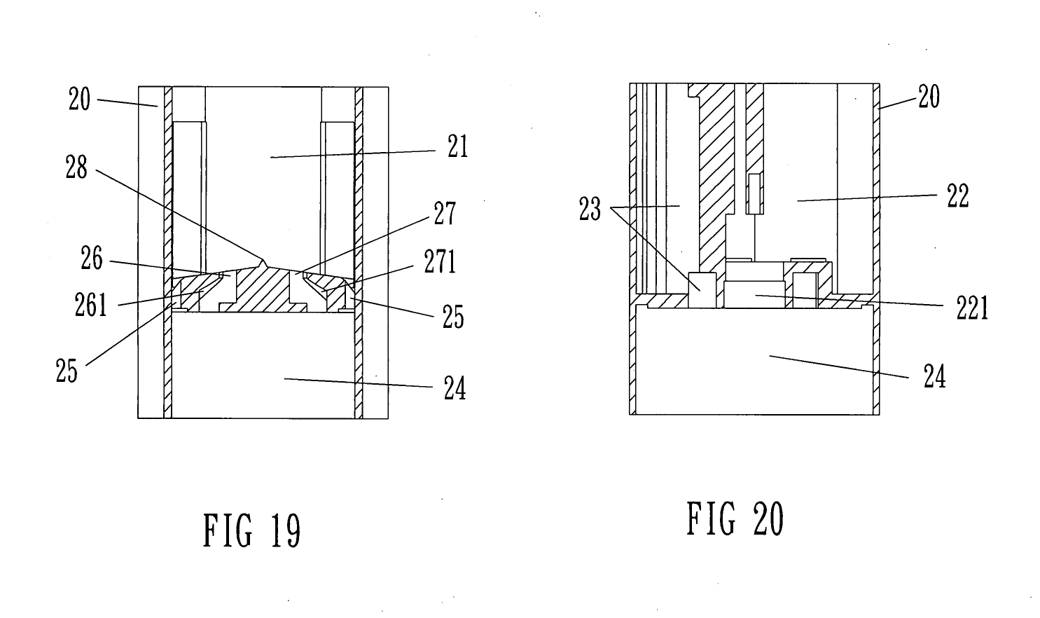

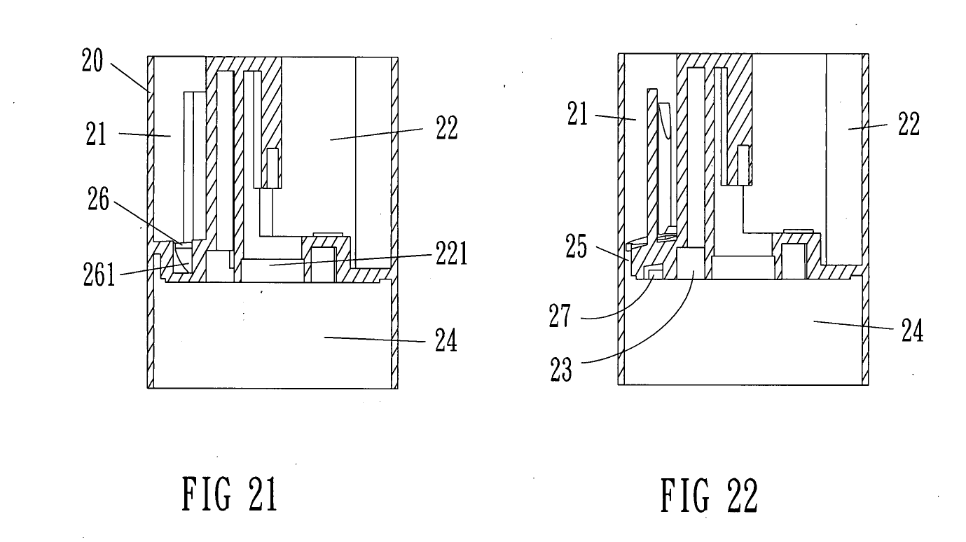

Referring to FIGS. 15 to 22, the lower tube 20 has a first lower receiving chamber 21, second lower receiving chamber 22, lower water path 23, and lower receiving space 24. A bottom of the lower receiving space 24 can be connected to a bottom tube 60. A top of the lower receiving space 24 below the first lower receiving chamber 21 has a linked outer ring water path 25, clockwise water path 26, and count-clockwise water path 27. An awl-shaped column 28 is formed between the clockwise water path 26 and the count-clockwise water path 27. A splitter 70 is arranged to the awl-shaped column 28. The twisting sheet 72 is arranged to a recess 71 formed to a top of the splitter 70. The twisting sheet 72 linked to the rod 50 will drive the splitter 70 to block the clockwise water path 26 or the count-clockwise water path 27. An awl-shaped recess 73 is formed to a bottom center of the splitter 70 so as to engage the awl-shaped column 28 as shown in FIG. 6. A lower axial hole 221 is formed to a bottom of the second lower receiving chamber 22. A first lower axial hole 222 and second lower axial hole 223 are formed next to the lower axial hole 221. The lower water path 23 is formed to two lateral sides of the first and second lower receiving chambers 21 and 22. A bottom of the lower water path 23 communicates with the lower receiving chamber 24. Referring to FIGS. 8, 16, and 19, an outlet of the clockwise water path 26 has a right slope 261 inclined from up to down, left to right so as to form a clockwise water flow. An outlet of the counterclockwise water path 27 has a left slope 271 inclined from up to down, right to left so as to form a counterclockwise water flow.

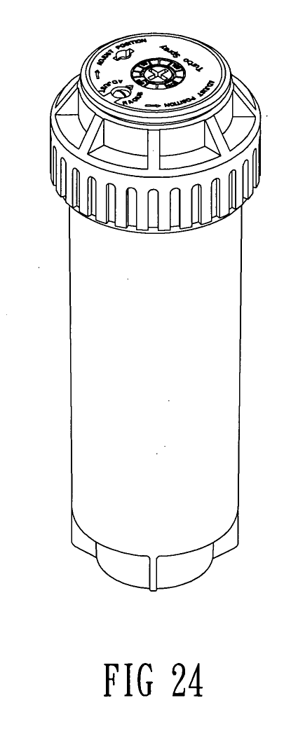

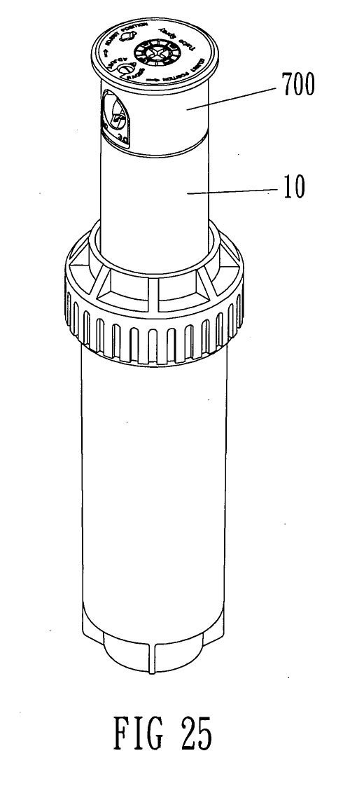

Referring to FIGS. 1, 4, 5, the upper cover 30 has an axial hole 31. The upper cover 30 is fixed to a predetermined position above the second upper receiving chamber 12 and beside the top receiving chamber 14 inside the upper tube 10 so that the upper independent chamber 400 is formed. The axial hole 31 is aligned with the upper axial hole 121 of the second upper receiving chamber 12. A driving shaft 80 is arranged between the upper axial hole 121 and the axial hole 31. Water seals 81 are arranged between the driving shaft 80 and the upper axial hole 121 and the axial hole 31 respectively. The driving shaft 80 has a central water path 82 having an upward open. A bottom of the driving shaft 80 has a gear 83, and the gear 83 is in the second upper receiving chamber 12. A plurality of lateral hole 84 is formed to a peripheral of a middle of the driving shaft 80 which communicates with the central water path 82. The plurality of lateral hole 84 is in the upper independent chamber 400. A plurality of protruded tooth 85 is formed near to an upper end of the driving shaft 80 for connecting a nozzle 700 as shown in FIGS. 24 and 25.

Referring to FIGS. 1, 2, 4, and 5, the lower cover 40 has a ring tank 41 having an upward open. A top of the lower cover 40 is fixed to the lower receiving space 24 of the lower tube 20 so as to form a lower independent chamber 500. A top of the lower independent chamber 500 communicates with the clockwise water path 26, count-clockwise water path 27, and the lower water path 23. The ring tank 41 can receive a vane gear 90. A column axle 91 and an upper gear 92 are from above a center of the vane gear 90. The column axle 91 can be fit into the lower axial hole 221 of the lower tube 20, and the upper gear 92 is in the second lower receiving chamber 22 of the lower tube 20.

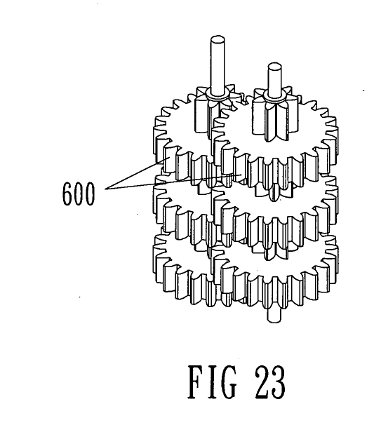

While the upper and lower tubes 10 and 20 are assembled in one, the first upper receiving chamber 11 and the first lower receiving chamber 21 are combined as the first independent chamber 100 and the second upper receiving chamber 12 and the second lower receiving chamber 22 are combined as the second independent chamber 200. The first and second upper axial holes 122 and 123 are aligned with the first and second lower axial holes 222 and 223 so as to receive a transmission gear 600 shown in FIG. 23. A bottom of the transmission gear 600 is engaged by the upper gear 92 of the vane gear 90. A top of the transmission gear 600 can be engaged by the gear 83 of the driving shaft 80. The upper water path 13 and the lower water path 23 are combined as the integral water path 300.

Therefore, water flow came into the first independent chamber 100 through the outer ring water path 25 of the lower receiving chamber 24 inside the lower tube 20 will be guided into the lower independent chamber 500 through the clockwise water path 26 or the count-clockwise water path 27. The vane gear 90 will be rotated clockwise or counterclockwise by the direction of the water flow. In the mean time, water flow will go into the integral water path 300 and reach the upper independent chamber 500. Finally, water flow will go into central water path 82 to the nozzle through the plurality of lateral hole 84.

Moreover, a plurality of through hole 42 is formed to a bottom of the lower cover 40. A protruded axle 43 is formed to an outer bottom of the lower cover 40. A compress spring 44 and a ring washer 45 are slid to the protruded axle 43. A bottom tube 60 is connected to the bottom of the lower tube 20. The bottom tube 60 has a round buffer tank 61 on a top thereof. A round hole 62 linking to a bottom tube hole 63 is formed to a bottom of the buffer tank 61. A plurality of round hole 64 is formed to a peripheral of the buffer tank 61 between the bottom tube hole 63. The plurality of round hole 64 communicates with the bottom tube hole 63. An independent chamber is formed between the buffer tank 61 and the bottom of the lower cover 40, the ring washer 45 will seal the round hole 62 of the buffer tank 61.

Therefore, while water supplied from the ring hole 64 of bottom tube 60 being sprinkled out of the central water path 82 of the driving shaft 80 through the outer ring water path 25 of the lower tube 20, excess water pressure can push the round washer 45 so that excess pressurized water will flow into the buffer tank 61 so as to be drained through the lower independent chamber 500. While the water pressure is back to normal, the round washer 45 pushed by the compress spring 44 will seal the round hole 62 again so as to automatically adjust water pressure.

Moreover, the transmission gear of the present invention shown in FIG. 23 is arranged by two sets of gear engaging to each other. Each gear set has a plurality of double-layer gear serially link by an axle, and the two axles are received by the first upper and lower axial holes and the second upper and lower axial holes respectively.

The embodiment of the water passage for embedded rotary sprinkler according to the present invention is shown in FIGS. 24 and 25.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A water passage for embedded rotary sprinkler comprising an upper tube (10), lower tube (20), lower cover (40), first independent chamber (100), integral water path (300), and lower independent chamber (500); wherein the first independent chamber (100) communicates with the lower independent chamber (500); the lower independent chamber (500) communicates with the water path (300).

2. The water passage for embedded rotary sprinkler as claimed in claim 1, wherein the upper tube (10) has a first upper receiving chamber (11) inside thereof; the first upper receiving chamber (11) has an upper water path (13); the lower tube (20) has a first lower receiving chamber (21), lower water path (23), and lower receiving space (24) inside thereof; while the upper and lower tubes (10) and (20) are assembled together, the first upper and lower receiving chamber (11) and (21) are combined as the first independent chamber (100) and the upper and lower water paths (13) and (23) are combined as the integral water path (300).

3. The water passage for embedded rotary sprinkler as claimed in claim 2, wherein the upper tube (10) has a second upper receiving chamber (12), and the lower tube (20) has a second lower receiving chamber (22); the second upper and lower receiving chamber are combined as the second independent chamber (200) for receiving a transmission gear (600).

4. The water passage for embedded rotary sprinkler as claimed in claim 2, wherein the cover (30) is arranged above the upper water path (13) so as form an upper independent chamber (400); a bottom of the upper independent chamber (400) communicates with the water path (300).

5. The water passage for embedded rotary sprinkler as claimed in claim 2, wherein a top receiving chamber (14) is formed above the upper receiving chamber (11); a through hole (15) is formed between the first receiving chamber (11) and the top receiving chamber (14); a rod (50) with a water seal ring (51) is arranged to the through hole (15); the water seal ring (51) is arranged between the through hole (15) and the rod (50).

6. The water passage for embedded rotary sprinkler as claimed in claim 2, wherein an outer ring water path (25), clockwise water path (26), and a counterclockwise water path (27) linking together are formed between a top of the lower receiving space (24) of the lower tube (20) and the first lower receiving chamber (21); the lower cover (40) is arranged to the lower receiving space (24); the lower cover (40) has a ring tank (41) having an upward open so that the lower independent chamber (500) is formed; the lower independent chamber (500) communicates with the clockwise water path (26), counterclockwise water path (27), and the lower water path (23).

7. The water passage for embedded rotary sprinkler as claimed in claim 6, wherein a plurality of through hole (42) is formed to a bottom of the lower cover (40); a protruded axle (43) is formed to an outer bottom of the lower cover (40); a compress spring (44) and a ring washer (45) are slid to the protruded axle (43); a bottom tube (60) is connected to the bottom of the lower tube (20); the bottom tube (60) has a round buffer tank (61) on a top thereof; a round hole (62) linking to a bottom tube hole (63) is formed to a bottom of the buffer tank (61); the ring washer (45) will push against the round hole (62); a plurality of round hole 64 is formed to a peripheral of the buffer tank (61) between the bottom tube hole (63).

8. The water passage for embedded rotary sprinkler as claimed in claim 6, wherein a vane gear (90) is received by the ring tank (41); a column axle (91) and an upper gear (92) are from above a center of the vane gear (90); the column axle (91) can be fit into a lower axial hole (221) of the lower tube (20), and the upper gear (92) is received inside the second lower receiving chamber (22) of the lower tube (20).

9. The water passage for embedded rotary sprinkler as claimed in claim 6, wherein an awl-shaped column (28) is formed between inlets of the clockwise water path (26) and the count-clockwise water path (27); a splitter (70) is arranged to the awl-shaped column (28); a rod (50) is arranged to a recess (71) formed to a top of the splitter (70); the rod (50) will drive the splitter (70) to block one of the clockwise water path (26) the count-clockwise water path (27).

10. The water passage for embedded rotary sprinkler as claimed in claim 4, wherein the cover 30 has an axial hole (31); the second upper receiving chamber (12) has an upper axial hole (121) aligned with the axial hole (31); a driving shaft (80) is arranged between the upper axial hole (121) and the axial hole (31). Water seals (81) are arranged between the driving shaft (80) and the upper axial hole (121) and the axial hole (31) respectively; the driving shaft (80) has a central water path (82) having an upward open; a bottom of the driving shaft (80) has a gear (83); a plurality of lateral hole (84) which communicates with the central water path (82) is formed to a peripheral of a middle of the driving shaft (80); a plurality of protruded tooth (85) is formed near to an upper end of the driving shaft (80) for connecting a nozzle (700).

11. The water passage for embedded rotary sprinkler as claimed in claim 3, wherein the transmission gear (600) is received by the second independent chamber (200); a bottom of the transmission gear (600) is engaged by an upper gear (92) of a vane gear (90); a top of the transmission gear (600) can be engaged by a gear (83) of a driving shaft (80).

12. A water passage for embedded rotary sprinkler comprising an upper tube (10), lower tube (20), upper cover (30), lower cover (40), first independent chamber (100), integral water path (300), upper independent chamber (400), and a lower independent chamber (500); wherein the first independent chamber (100) communicates with the lower independent chamber (500); the lower independent chamber (500) communicates with the integral water path (300); the integral water path (300) communicates with the upper independent chamber (400).

13. The water passage for embedded rotary sprinkler as claimed in claim 12, wherein a second independent chamber (200) is formed next to the first independent chamber (100) and the integral water path (300); a transmission gear (600) is received to the second independent chamber (200).

14. The water passage for embedded rotary sprinkler as claimed in claim 12, wherein an outer ring water path (25), clockwise water path (26), and a counterclockwise water path (27) are formed to the lower tube (20) near to the first independent chamber (100); the clockwise water path (26) and a counterclockwise water path (27) communicate with the lower independent chamber (500); the outer ring water path (25) is formed outside the lower independent chamber (500).
